(19) United States
(12) Patent Application Publication
(10) Pub. No.: US 2017/0364212 A1
(43) Pub. Date: Dec. 21, 2017

(54) APPLICATION RENDERING FOR DEVICES WITH VARYING SCREEN SIZES

(71) Applicant: SAP SE, Walldorf (DE)

(72) Inventors: Xingtian Shi, Shanghai (CN); Wen-Syan Li, Shanghai (CN)

(21) Appl. No.: 15/183,205

(22) Filed: Jun. 15, 2016

(51) Int. Cl. G06F 3/0482; H04L 29/08; G06F 3/0484

(52) U.S. Cl. CPC G06F 3/0482; G06F 3/0484; H04L 67/22

(57) ABSTRACT

Techniques are provided for rendering network applications in a highly-customized manner, in which, for example, user interactions with one or more network applications using devices having different screen sizes are analyzed and used to assign user preferences and priorities with respect to the one or more network application(s). In this way, users may be provided with desired and useful content in a convenient manner, while application providers may have their content rendered in a manner that increases a likelihood of achieving an intended result (e.g., consummating a sale or other transaction, or eliciting some other desired reaction from the user).

### TECHNICAL FIELD

This description relates to rendering user interfaces of applications.

### BACKGROUND

Users of network applications frequently access such network applications using devices of varying screen sizes. For example, a user might access a network application on a first device having a first screen size, such as a mobile phone or smartwatch, and then access the network application on a second device having a second screen size, such as a laptop or desktop computer. Of course, the user might access the network application in the reverse order of screen sizes, and/or may use three or more devices over time.

Network applications often have more application components than can be rendered on a given screen size in a convenient or effective manner. For example, if it is possible to render a network application in its entirety using a desktop computer and associated monitor, it may be undesirable to attempt to render the same network application using a smartphone, for the simple reason that the rendered content will likely be too compressed and too small to be effectively used and enjoyed.

As a result, application providers may render different application components on two or more different screen sizes. For example, application providers often have a desktop or full version of a network application, as well as a mobile version designed for display using a mobile device. In the mobile version, some application components may be rearranged or rendered differently than in the desktop version, while other application components may (at least initially) be omitted in their entirety.

Although these and related techniques provide some advantages, users may still find that content rendered on a given device fails to meet those users' preferences or requirements. Moreover, the application providers may find it ineffective and expensive to design and provide multiple versions of their network application(s).

### SUMMARY

In the present description, techniques are provided for rendering network applications in a highly-customized manner, in which, for example, user interactions with one or more network applications using devices having different screen sizes are analyzed and used to assign user preferences and priorities with respect to the one or more network application(s). For example, if a user selects particular application components while using a smartphone, then those application components may be selected in a prioritized manner when rendering the same network application using a desktop computer. Conversely, but similarly, application components selected by a user using a desktop computer may be rendered in a prioritized manner when rendering the same network application using a smartphone. Further, other factors, such as a user profile for the user, and/or a current user context (e.g., location or current time) of the user, may be used in selecting application components for a current rendering of the network application. One or more machine learning algorithms may be used to predict which application component(s) should be rendered at a given time and with a given device (and associated screen size), as well as how the selected/determined application components, and related aspects, should be rendered. In this way, users may be provided with desired and useful content in a convenient manner, while application providers may have their content rendered in a manner that increases a likelihood of achieving an intended result (e.g., consummating a sale or other transaction, or eliciting some other desired reaction from the user).

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for application rendering for devices with varying screen sizes.

FIG. 2 is a flowchart illustrating example implementations of the system of FIG. 1.

FIG. 3A illustrates a first example screenshot that might be provided using the system of FIG. 1.

FIG. 3B illustrates a second example screenshot that might be provided using the system of FIG. 1.

FIG. 4 is a flowchart illustrating example techniques for calculating a weight adjustment model used in the examples of FIGS. 1-3.

FIG. 5 is a flowchart illustrating example techniques for utilizing the weight adjustment model of the example of FIG. 4.

FIG. 6 is a block diagram illustrating an example process flow for the system of FIG. 1.

### DETAILED DESCRIPTION

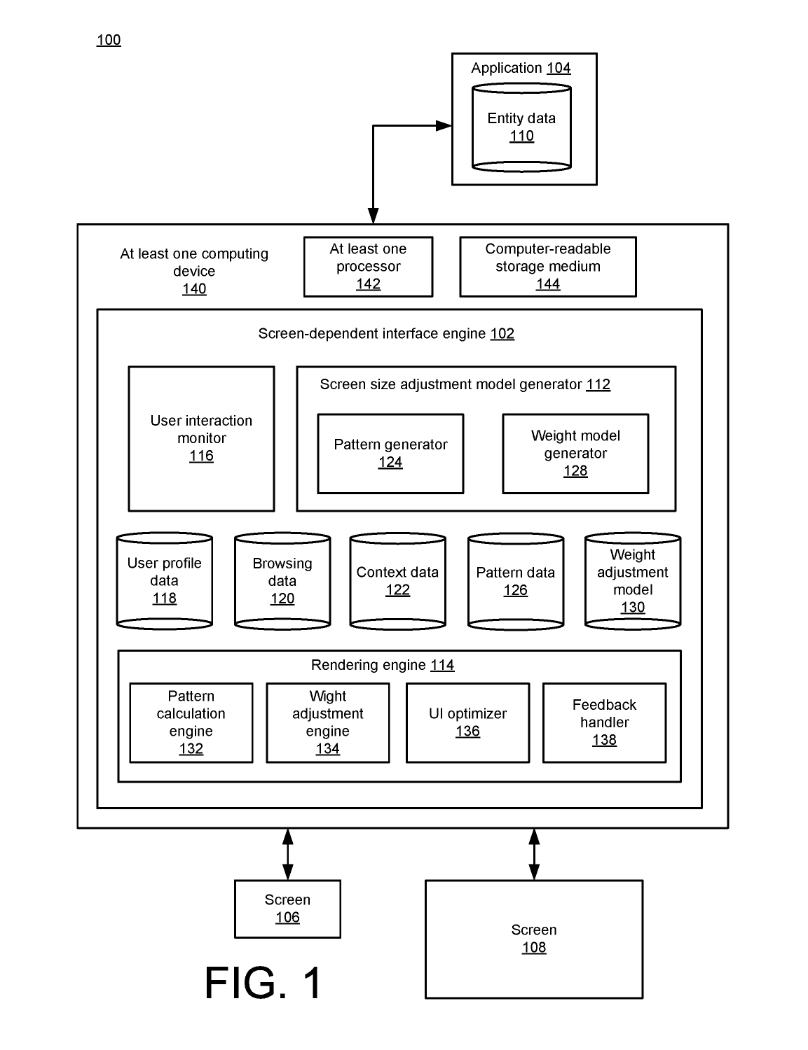

FIG. 1 is a block diagram of a system 100 for application rendering for devices with varying screen sizes. In the example of FIG. 1, a screen-dependent interface engine 102 may be configured to render personalized versions of at least one graphical user interface (GUI) of an application 104 on each of a screen 106 having a first size and a screen 108 having a second size. More particularly, as referenced above and described in detail herein, the screen-dependent interface engine 102 may be configured to learn or infer GUI-related user preferences for a particular user (or class, group, or type of user(s)) while rendering the at least one GUI for one of the screens 106, 108, and may be further configured to render a different, personalized version of the at least one GUI for the particular user when the user is using the other screen of the screens 106, 108. Accordingly, the user is more likely to experience a desired, enjoyable, and useful version of the application 104, and a provider of the application 104 is more likely to achieve desired goals (e.g., high user satisfaction levels, or consummation of transactions)

In the example of FIG. 1, the application 104 should be understood to represent virtually any network application that may be rendered using one or more graphical user interfaces at the screens 106, 108. In many of the following examples, the application 104 may be described as including an application provided to the general public by way of the public Internet, including e-commerce and other applications designed to consummate transactions for goods and services between the provider of the application 104 and consumers using devices having the screens 106, 108.

Of course, as just referenced, such applications should be understood to represent non-limiting examples of the network application 104. A non-exhaustive list of additional or alternative examples of the application 104 may include enterprise software or other software designed to be accessed using a private network and/or secured connection over the public Internet, applications designed to provide a specific service or function (such as search engines), and various other types of current or future network applications, as would be apparent to one of skill in the art.

As illustrated in the example of FIG.1, the application 104 may be constructed at least in part using a plurality of application entities, represented in FIG. 1 by entity data 110. As explained in further detail below, such entities generally represent objects, actions, or other aspects of the application 104 that may be rendered or otherwise provided in one or more graphical user interfaces utilized by the screens 106, 108.

For example, an entity may represent a visual rendering of a real world object, such as a product for sale. In other examples, an entity might represent a visualization of something less concrete or tangible, such as a software entity (e.g. a data structure, a map, or a service to be performed, to name a few examples). Additionally, or alternatively, entities may refer to specific portions of the rendered application, such as structural elements provided within a graphical user interface. Non-limiting examples of these may include frames, scroll bars, icons, buttons, or other widgets used to render data or control aspects of a visual display thereof. In short, and although additional detailed examples are provided below, entity data 110 should be generally understood to represent virtually any discrete item or aspect of the application 104 that might be rendered in a graphical user interface of the screens 106, 108.

Meanwhile, the screens 106, 108 should generally be understood to represent screens of corresponding devices of varying sizes. For example, such devices may include, but are not limited to, desktop computers, netbook, notebook, or tablet computers, mobile phones or other mobile devices, smartwatches, televisions, or virtually any other device that includes a screen and is capable of rendering the application 104. In some implementations, a screen need not be a part of, or integral with, such devices. For example, a screen may include a projected image of a rendering of the application 104, such as a 2D projection onto a screen, or a 3D projection of a rendering of the application 104 within a defined space.

In various implementations, each such screen may be associated with an application that executes specific renderings of the application 104, e.g., of graphical user interfaces thereof. Although virtually any special purpose rendering application might be used, the various examples provided herein generally assume that the screens 106, 108 and any associated devices utilize a browser application, such as one or more of the popular and publicly available browsers, including Internet Explorer by Microsoft, Chrome by Google, Mozilla by Firefox, or Safari by Apple.

In operation, the screen-dependent interface engine 102 may be configured to utilize a screen size adjustment model generator 112 configured to execute one or more various types of machine-learning or other algorithms for learning, generalizing, and predicting user preferences regarding renderings of the application 104 using the varying screen sizes 106, 108. That is, as should be apparent from the above description of example devices provided with screens 106, 108, the screens 106, 108 may vary significantly in size with respect to one another. For example, in the illustration of FIG. 1, the screen 106 is illustrated as being relatively smaller than the screen 108. For example, the screen 106 might be implemented using a smartwatch or a smartphone, while the screen 108 might represent a tablet or a desktop computer screen.

In operation, the screen size adjustment model generator 112 proceeds on the assumption that certain actions of a user or type of user with a rendering of the application 104 in the context of the screen 108 will be informative as to preferences of the same user or type of user when viewing a rendering of the application 104 using the screen 106. For example, in a simplified scenario, if the screen 108 is initially used to render a number of entities of the entity data 110, and a user interacts primarily or exclusively with a specific subset of such entities, then a later rendering of the application 104 in the context of the smaller screen 106 may be configured to render the specific subset of entities primarily or exclusively.

In addition to making such inferences from user interactions with the relatively larger screen 108 for use in future renderings of the application 104 using the relatively smaller screen 106, the screen size adjustment model generator 112 may be configured to make conceptually similar inferences with respect to interactions of the user with the relatively smaller screen 106, for use in future renderings of the application 104 in the context of the relatively larger screen 108. For example, when presented with a rendered subset of entities of the application 104 within the screen 106, the user may initially reject a majority or entirety of rendered entities, and thereafter be provided with additional or alternative entities. Based on which such entities the user elects to utilize, the screen size adjustment model generator 112 may proceed to make corresponding inferences, generalizations, and predictions regarding rendering preferences of the same or similar user with respect to the relatively larger screen 108.

Based on such inferences, generalizations, and predictions, a rendering engine 114 may be configured to render a current version of the application 104 in a highly customized, efficient, and effective manner. For example, although the simplified example of FIG. 1 illustrates only the two screen sizes 106, 108, it will be appreciated from the present description that the screen size adjustment model generator 112 may make inferences, generalizations, and predictions regarding renderings of the application 104 using a larger number of devices and associated screens. For example, the screen size adjustment model generator 112 may operate with respect to a number of screens that may be larger than the screen 106. Then, at a time of a rendering request by a user of the screen 106, the rendering engine 114 may utilize one or more of the outputs of the screen size adjustment model generator 112 in providing real time or near real time rendering of specific application entities of the entity data 110 of the application 104 for inclusion within the screen 106.

In order to provide these and related functions, both the screen size adjustment model generator 112 and the rendering engine 114 may be provided with access to one or more user interaction monitors, represented in the example of FIG. 1 by a user interaction monitor 116. For example, the screen size adjustment model generator 112 may utilize outputs of the user interaction monitor 116 in monitoring interactions of the user with the screen 108, in order to determine inferences, generalizations, predictions, and other learning with respect to the monitored interactions. Then, at a later time, the rendering engine 114 may utilize then-current interactions of the user with the screen 106, in order to utilize the learning of the screen size adjustment model generator 112 in a manner that is appropriate or useful for a current rendering of the application 104 using the screen 106.

In practice and in operation, the screen-dependent interface engine 102 collects, accesses, processes, generates, or otherwise utilizes various types of data. For example, user profile data 118 refers to various types of data characterizing an individual, unique user, and/or identified groups or classes of users. In some implementations, each user or class of users is represented using a corresponding data structure stored within the user profile data 118. In general, the user profile data 118 may include virtually any data characterizing the user that may be instrumental in operations of the screen size adjustment model generator 112 and the rendering engine 114. For example, the user profile data 118 may include an age, gender, or other physical characteristic of a user. In other examples, the user profile data 118 may store a type of device or devices used by the user, as well as preferences of the user. Additional or alternative examples of the user profile data 118 are provided below, or would be apparent.

Meanwhile, browsing data 120 represents data collected by the user interaction monitor 116, or otherwise obtained by the screen-dependent interface engine 102, and that represents actions taken by a corresponding user or class of users while navigating rendered instances of the application 104, and/or while navigating rendered graphical user interfaces using the devices associated with the screens 106, 108. For example, such interactions may include selections made by the user, transactions consummated by the user, text or other input received from the user, or virtually any interaction reflecting a choice made by the user.

The browsing data 120 also may include metadata characterizing such user actions. For example, the browser data 120 may include a quantity of time spent by the user in conjunction with making a particular selection. The browsing data 120 also might specify choices not made by the user, such as when certain options are presented to the user and the user repeatedly rejects or ignores such options. Somewhat similarly, the browsing data 120 may include data characterizing sequences of user interactions.

In some implementations, the browsing data 120 may include, or be defined with respect to, the various entities of the entity data 110. In other words, the browsing data 120 may reflect user actions taken that are specific to, or related to, the application 104 itself. In additional or alternative implementations, the browsing data 120 may include actions taken by a user with respect to a corresponding screen of the screens 106, 108, and/or with respect to a third party browser application being displayed therewith, so that such actions should be understood to be partially or completely independent of the particular application 104 being rendered. For example, the browsing data 120 may reflect a usage of a particular browser extension or other functionality that is not native to the application 104, but that can be used in conjunction with operations of the application 104. Additional or alternative examples of the browsing data 120 are provided below, or would be apparent to one of skill in the art.

Another type of data that may be utilized by the screen-dependent interface engine 102 is context data 122, representing contextual data associated with a user and determined in conjunction with a point or points in time during which the user executed certain actions and (directly or indirectly) expressed certain preferences. In other words, context data 122 generally represents a set of circumstances associated with a particular user, and with expressed interests of that user. In particular, context data may include, for example, a location and time that a particular application rendering is provided to a given user, or other applications being used concurrently with the application 104. Thus, the context data 122 may include virtually any data associated with particular circumstances of the user and stored in conjunction with actions taken by the user while those circumstances were relevant. Additional examples of context data 122 are provided below, or would be apparent to one of skill in the art.

Screen size data may be understood to represent a particular type of context data, since screen size of a device being used is part of the circumstances of a user when viewing the application 104. Therefore, it is feasible to include screen size data within the context data 122, although of course, screen size data may be stored separately, as well. In any case, as described in detail herein, relative screen sizes between two or more renderings of the application 104 are used as determining factors in applying the pattern data 126, weight adjustment model 130, and otherwise in rendering a personalized, screen-dependent version of the application 104 using the rendering engine 114.

Some or all of the user profile data 118, the browsing data 120, and the context data 122 may be obtained by one or more instances of the user interaction monitor(s) 116, and/or may be accessed from other sources (e.g., from other databases, not shown, or by way of direct input received from the user). Further, the user profile data 118, the browsing data 120, and the context data 122 may be utilized by both the screen size adjustment model generator 112 and the rendering engine 114. In particular, as described in more detail below, the screen size adjustment model generator 112 may utilize the various databases 118-122 while executing various types of machine learning to enable predictions regarding desired renderings of a particular user. As explained in detail below, such predictions may be dependent upon values for relevant portions of the data 118-122 that are relevant at a time the prediction is being made. Consequently, as also explained in detail below, the rendering engine 114 also may be configured to access data of the various databases 118-122 at a time of executing a particular rendering of the application 104 in the context of one of the screens 106, 108, so as to determine which of a plurality of predictions that the screen size adjustment model generator 112 is capable of making will be most relevant or otherwise most desirable for the user in question at the time of the rendering being requested.

The screen size adjustment model generator 112 is configured to utilize the various types of data 118, 120, 122, together with the entity data 110, to quantify and characterize user preferences for a particular user or type of user. In more detail, the screen size adjustment model generator 112 includes a pattern generator 124 that is configured to construct one or more ordered list of relevant entities of the entity data 110, based on the user profile data 118, the browsing data 120, and the context data 122. Put another way, a pattern generated by the pattern generator 124 should be understood to represent an information filter expressed as a function that returns an ordered list of entities based on the entities' respective level of relevance to the pattern in question. For example, a pattern might express a type of product or service preferred by a user, or a manner in which the user prefers to view or access types of data. In the latter case, for example, the pattern may reflect a user's preference to sort hotels or other goods or services being viewed in an ascending order, based on price.

Thus, by accessing the collected user profile data 118, browsing data 120, context data 122, and entity data 110, the pattern generator 124 may execute one or more various types of machine learning algorithms, some of which are described in more detail below, in order to construct a plurality of patterns determined to be relevant to the user in question. Then, the pattern generator 124 may store all derived patterns within pattern data 126, as shown in FIG. 1. Further in FIG. 1, the screen size adjustment model generator 112 includes a weight model generator 128, which is configured to assign relative weights to the various patterns of the pattern data 126.

In other words, a user interest of a particular user may be defined as a mixture or combination of multiple patterns, where a weight is attached to each one of the patterns in the combination of patterns. Thus, the weight model generator 128 generates a weight adjustment model 130 stored in a corresponding database, in which the user interest of the user in question is expressed as a combination of patterns from the pattern data 126, with each pattern being assigned a relative weight corresponding to a relative level of interest or importance associated with that pattern for the user in question.

Then, the rendering engine 114, at a time in which a specific rendering of the application 104 has been requested, may utilize the pattern data 126 and the weight adjustment model 130 in determining a manner in which to render the requested application content for a particular screen size being used by a particular user at that point in time. In other words, it should be appreciated from the above discussion that the pattern generator 124, over a period of time, may generate a relatively large number of patterns for inclusion within the pattern data 126. For example, such patterns may be generated with respect to the screen 108, and/or one or more other screens. The pattern data 130 may reflect, or be associated with, various aspects or subsets of the user profile data 118, the browsing data 120, and the context data 122. Similarly, weights attached to the various patterns, or various relevant subsets of the various patterns, will vary in accordance with the weight adjustment model 130.

At a time of a requested rendering, a pattern calculation engine 132 of the rendering engine 114 will thus determine which patterns of the pattern data 126 are most likely to be relevant or useful in fulfilling the rendering request, e.g., for the screen 106. Once the pattern calculation engine 132 has selected the relevant subset of patterns from the pattern data 126, a weight adjustment engine 134 may utilize the weight adjustment model 130 to express a current, relevant user interest for the user of the screen 106 as an appropriately weighted combination of the selected patterns of the pattern data 126.

More detailed explanations of operations of the pattern calculation engine 132 and the weight adjustment engine 134 are provided in more detail, below. In general, however, it will be appreciated that the pattern calculation engine 132 may be configured to select relevant patterns of the pattern data 126 based on data received from the user interaction monitor 116, and/or data accessed from the user profile data 118, the browsing data 120, and the context data 122. Similar comments apply to the weight adjustment engine 134. In other words, selection and weighting of the various patterns for a particular rendering request will vary based on many factors, including a relevant screen size of the screen 106, other current circumstances or contexts of the user, current or preceding browsing actions of the user, and one or more elements of the user profile of the user.

Once a current weighted combination of patterns has been obtained, a UI optimizer 136 may leverage the weighted combination of patterns to, e.g., optimize layout of a page rendered for the screen 106. For example, the UI optimizer 136 may leverage existing application layout techniques used in other rendering techniques and scenarios. Some of examples of such layout optimization are provided below in more detail, or would apparent to one of skill in the art.

Finally with respect to the rendering engine 114, a feedback handler 138 may be configured to determine a response of the user with respect to the rendering performed by the rendering engine 114. For example, the feedback handler 138 may receive direct feedback from the user, or may infer feedback from actions taken by the user and obtained by the user interaction monitor 116. In any case, the feedback handler 138 may be configured to provide the determined feedback to the screen size adjustment model generator 112.

In this way, the pattern generator 124 and/or the weight model generator 128 may be configured to adjust the pattern data 126 and the weight adjustment model 130 in a manner which more accurately reflects user interest and preferences of the user in question. For example, if the user acted in accordance with the weight adjusted pattern combinations used by the rendering engine 114, then the feedback handler 138 may provide such feedback to the screen size adjustment model generator 112 for purposes of reinforcing the existing pattern data 126 and weight adjustment model 130. On the other hand, if the user does not act in accordance with the rendered aspects of the application 104, and/or the feedback handler 138 receives specific negative feedback from the user, then the feedback handler 138 may instruct the screen size adjustment model generator 112 to respond accordingly. For example, the weight model generator 128 may assign a relatively smaller weight to rendered aspects of the application 104 that were not selected, or deselected, by the user.

In the example of FIG. 1, the screen-dependent interface engine 102 is illustrated as being executed using at least one computing device 140, which includes one processor 142, as well as a non-transitory computer readable storage medium 144. Thus, in the example implementation of FIG. 1, the screen-dependent interface engine 102 may be implemented as a third party middleware for one or more applications, such as the application 104. In these and similar contexts, it is possible that the screen-dependent interface engine 102, e.g., the user interaction monitor 116, may collect various, related types of data across a plurality of applications. For example, the screen-independent interface engine 102 may determine a common pattern for a particular user across a plurality of applications (e.g., such as a sensitivity to price).

In additional or alternative implementations, the screen-dependent interface engine 102 may be implemented specifically in conjunction with, e.g., as a part of, the application 104. In still other implementations, the screen-dependent interface engine 102, or portions thereof, may be implemented as a client service, such as by installing one or more instances of the screen-dependent interface engine 102 on one or more user devices of a particular user.

As also may be appreciated from the above description, various portions or modules of the screen-dependent interface engine 102 may be implemented in two or more of the various computing platforms just referenced. For example, instances of the user interaction monitor 116 may be implemented at individual ones of a plurality of devices of a user, while other portions of the screen-dependent interface engine 102 are implemented at a third party server and/or at a server providing the application 104.

More generally, although the various modules, components, and aspects 112-138 of the screen-dependent interface engine 102 are illustrated as being separate and discrete from one another, it will be appreciated that, e.g., any two or more of the various modules or sub-modules may be combined for implementation as a single module or sub-module. Similarly, but conversely, any single module or sub-module may be further divided for implementation as two or more individual sub-modules.

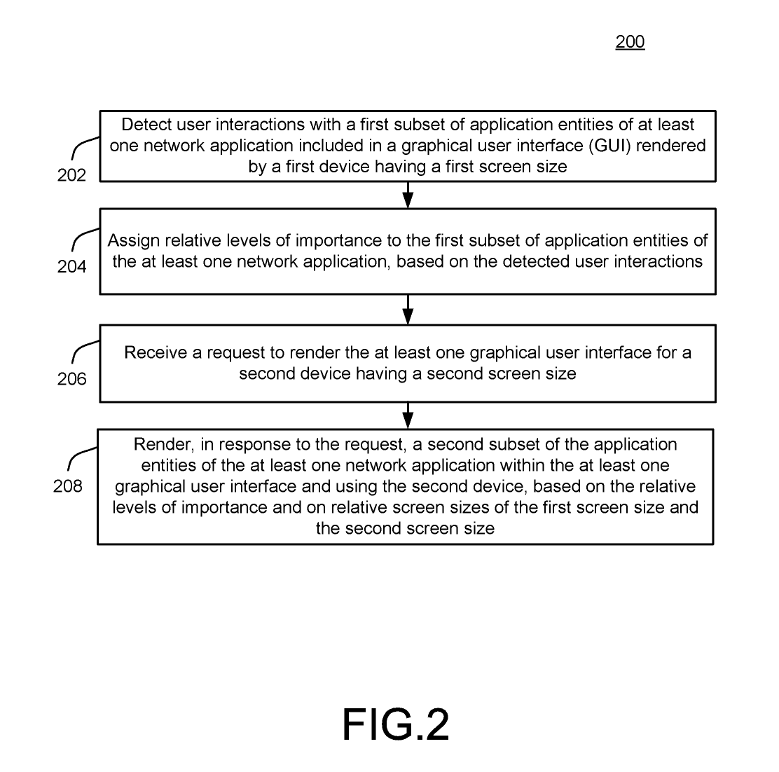

FIG. 2 is a flowchart 200 illustrating example operations of the system 100 of FIG. 1. In the example of FIG. 2, operations 202-208 are illustrated as separate, sequential operations. In other example implementations, additional or alternative operations or sub-operations may be included, and/or one or more operations or sub-operations may be omitted. In these and other example implementations, it will be appreciated that any two or more of the included operations or sub-operations may be executed in a partially or completely overlapping or parallel manner, or in a nested, iterative, looped, or branched fashion.

In the example of FIG. 2, user interactions with a first subset of application entities of at least one network application included in a graphical user interface (GUI) rendered by a first device having a first screen size are detected (202). For example, the user interaction monitor 116 may be configured to detect selections of a user with respect to a rendering of a subset of application entities of the entity data 110 of the application 104, in the context of the screen 108.

Relative levels of importance may be assigned to the first subset of application entities of the at least one network application, based on the detected user interactions (204). For example, the screen size adjustment model generator 112 may be configured to assign relative levels of importance to individual ones of the first subset of application entities, so as to establish one or more ordered lists of entities as patterns to be stored within the pattern data 116, where, as described, combinations of patterns may each be assigned corresponding weights for each pattern, in order to express one or more quantified expressions of user interest, by way of the weight adjustment model 130.

It will be appreciated that the referenced first subset of application entities may include multiple subsets of application entities viewed by a user in multiple circumstances and contexts, including multiple devices and/or multiple screen sizes. Accordingly, the relative levels of importance assigned may be associated with different ones of, or different combinations of, the various subsets of application entities utilized by the user in the various different circumstances and context. Again, such example implementations should be understood to include the example scenarios provided above with respect to FIG. 1, in which each pattern of the pattern data 126 includes an ordered combination of a subset of application entities, and the weight adjustment model 130 provides relative weights as the relative levels of importance that may be assigned to each pattern in a combination of patterns expressing a particular user interest.

Then, a request may be received to render the at least one graphical user interface for a second device having a second screen size (206). For example, the rendering engine 114 may be configured to receive a request from a user of a device having the screen 106 included therein.

In response to the request, a second subset of the application entities of the at least one network application may be rendered within the at least one graphical user interface and using the second device, based on the relative levels of importance and on relative screen sizes of the first screen size and the second screen size (208). For example, the rendering engine 114 may be configured to determine which of the application entities and relative levels of importance thereof will be relevant for the requested rendering, and may proceed to optimize a layout of the application 104 within a corresponding GUI rendered using the screen 106.

Thus, the screen-dependent interface engine 102, e.g., the screen size adjustment model generator 112, is configured to assign relative levels of importance to application entities 110, including training a model of a machine learning algorithm, based on user interactions. Then, the rendering engine 114 is configured to render the second subset of the application entities including applying the trained model to the application entities 110 of the at least one network application 104.

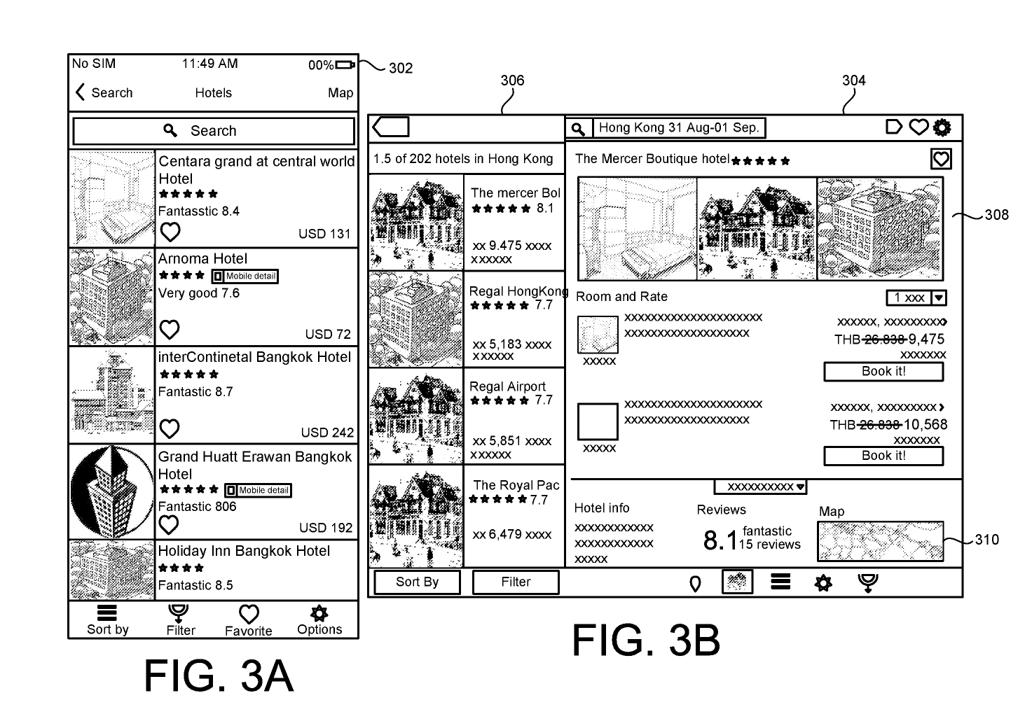

FIGS. 3A and 3B illustrate example screen shots that may be generated using the system 100 of FIG. 1. In the example of FIG. 3A, a first screen shot 302 may correspond to a relatively small screen such as the screen 106, e.g., a mobile device or smartphone. Meanwhile, in FIG. 3B, a screen shot 304 represents a rendering of the same application of the screenshot 302, using a larger screen corresponding generally to the screen 108 of FIG. 1, such as a tablet or desktop computer screen.

As may be observed from the example of FIGS. 3A and 3B, FIGS. 3A and 3B illustrate a scenario in which the application 104 provides information regarding hotels. As may be appreciated from the above description of FIGS. 1 and 2, the rendering and layout of the screen shot 302 is different than that of the screen shot 304, although the primary theme of hotel information is included in both of the screen shots 302, 304.

In more detail, as shown, the screen shot 302 lists a number of available hotels, along with price information, customer ratings, in a single representative picture. In contrast, the screen shot 304 is relatively expanded, and includes additional pictures 306, expanded information regarding room choices and rates in a section 308, and a hotel address and map illustrated in a portion 310.

In the examples of FIGS. 3A and 3B, it would be appreciated that the screen shot 302 may illustrate a layout of the underlying application that is rendered at least in part based on actions taken by the user with respect to the screen shot 304. In subsequent renderings using the screen of the screen shot 302, intervening actions taken by the user and/or changes in the context of the user may dictate changes in the layout. For example, if the user selects the map in the portion 310 of the screen shot 304, the screen size adjustment model generator 112 of FIG. 1 might determine that the user is sensitive to a location of the hotel. If a pop-up map is provided in response to the user's selection in the portion 310, and the user requests directions from the hotel displayed to the city center of the city in which the hotel is located, it may be determined that the user prefers hotels in relatively close proximity to the city center.

Thus, FIG. 3 illustrates simplified examples demonstrating ability of the screen-dependent interface engine 102 to utilize inferred user interests for the purpose of improving application layouts of renderings executed on devices having different (e.g., smaller) screen sizes. As also described, user interests inferred from interactions with a relatively larger screen shot 304 may be used to optimize a layout in rendering the screen shot 302. Alternatively, and conversely, user interests inferred from interactions with the display of the screen shot 302 may be generalized and otherwise leveraged in making at least some choices regarding a layout and rendering of the screen shot 304, or any other larger or smaller screen size.

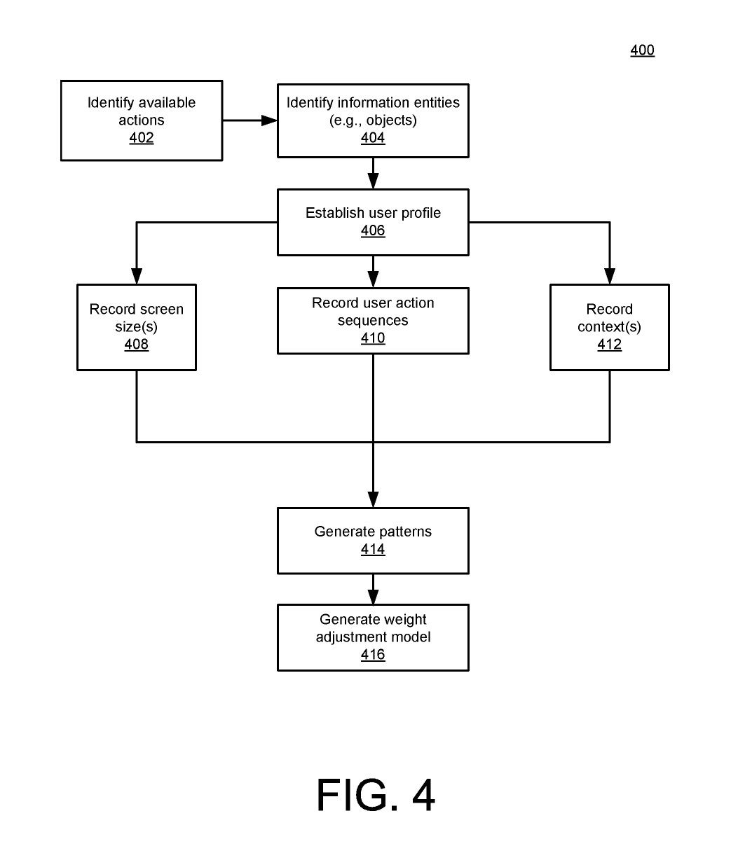

FIG. 4 is a flowchart 400 illustrating example operations of the screen size adjustment model generator 112. As already generally described above with respect to FIG. 1, the screen size adjustment model generator 112 is configured to collect user profile data 118, user browsing data 120, and context data 122 associated with the user and/or the browsing. As described herein, the relative screen sizes used by the user at different points in time might conceptually be considered for inclusion within the context data 122, and/or may be stored in conjunction with the browsing data 120 (e.g., browsing data may be stored in conjunction with corresponding screen sizes of devices used for the particular browsing data being stored). Additionally, or alternatively, screen size information may be stored in the context of the user profile data 118, such as when multiple devices (and their respective screen sizes) are stored within the user profile data 118 as being owned by, or accessible to, the user in question.

Using the data 118, 120, 122, the screen size adjustment model generator 112 is configured to execute a learning phase in which the pattern generator 124 models user behavior (e.g., browsing history) and generates patterns to be stored within the pattern data 126. Then, different patterns associated with different screen sizes may be analyzed, so that the weight model generator 128 may proceed to build the weight adjustment model 130 that reflects a manner in which different screen sizes might influence selections in uses of the patterns of the pattern data 126.

Thus, in the example of FIG. 4, available user actions may be identified (402). For example, as referenced above, some available actions may be defined in terms of native functions of the screens 106, 108, or of a browser or other rendering application used in conjunction therewith. In other example scenarios, user actions may be specific to the application 104 and/or the entity data 110.

Relevant information entities may be identified (404). For example, the entity data 110 may represent available objects and related actions or characteristics associated therewith, or other aspects of the application 104, or other applications. As already referenced, individual information entities of the entity data 110 may be utilized to model an object that might be included or illustrated within a relevant application layout to be rendered. For example, an information entity may represent a product, such as a particular smartphone for sale, or a particular hotel, such as the “Frankfort Marriott.” In the following examples, an information entity of the entity data 110 will be denoted as: eₖ.

A user profile may be established (406). As referenced above, the user profile data 118 includes a data structure for each user or type of user, and may be stored in memory or disc. Each user profile may describe, e.g., a user's personal attributes. Examples include demographic information, such as gender, residence, or education. A user profile was used to model a given user as an entity within the system 100. As such, the user profile may be utilized to compare similarities between different users, and to link individual users with corresponding user browsing patterns. In general, a user profile may be denoted as shown in Equation 1:

uᵢ=<xᵢ₁, xᵢ₂, . . . > Equation 1

In which xᵢ₁,xᵢ₂, . . . represent attributes of the user ui. In some implementations, a distance function may be expressed to represent a distance between two or more different user profiles, e.g., dist(uᵢ,uⱼ). In other words, the distance function may express relative levels of similarity between two or more users, so that very similar users may be used in conjunction with one another for the various operations described herein. For example, extremely similar user profiles may be used by the screen size adjustment model generator 112 to generate either or both of the pattern data 126 and the weight adjustment model 130, and may be utilized by the rendering engine 114 in determining and executing application layout optimizations for current and future application renderings.

In conjunction with user browsing or other interactions with at least one rendering of the application 104 begin, corresponding screen sizes may be recorded (408). For example, the user interaction monitor 116 may monitor user interactions with one or both of the screens 106, 108, as well as actual screen sizes (e.g., screen resolutions) of the screens 106, 108 during uses thereof.

The browsing data 120 may be populated, also through the use of one or more available instances of the user interaction monitor 116, by recording user action sequences that occur during interactions with, e.g., a rendering using the screen 108 (410). In other words, both the individual user actions taken with respect to the rendering of the application 104, as well as an identified sequence of multiple actions, may be recorded.

Notationally, an action sequence taken by a user when browsing a rendering of the application 104 using a screen such as the screen 108 may be represented using Equation 2:

bᵢ₍ₜᵢₘₑ₎={action₁, action₂, . . . } Equation 2

As may be observed from Equation 2, i represents the user (e.g., user profile), and the parameter “time” represents a time stamp of the time at which the action sequence {action₁, action₂, . . . } occurs. As may be appreciated from the above description, such actions may include, e.g., a particular entity is clicked after 10 seconds, sorting criteria is changed to distance, an identified screen tab is closed, or a purchase transaction is executed.

Further, context data that exists during, or in conjunction with, recorded screen sizes and action sequences may be recorded (412). As described above, the context data 122 that is recorded generally refers to a set of circumstances associated with a given user, and with respect to a corresponding user interest or interests, at a given time, location or other setting or situation of the user. For example, as just referenced, context may be understood to include a location and time at which a particular application layout is rendered for the user. Context also may include other devices or device components that are in use at a given time/location, such as other applications or sensors being used by a user during a particular rendering of an application layout. In other examples, graphical and temporal context data may be associated with further relevant particularities, such as when a time is associated with a lunch break of a user, and a location is associated with a restaurant.

As will be explained in more detail below, the context data builds a link between the user profile, the user browsing behavior, and characterizations of the user's interest, as expressed using the generated patterns and associated weight adjustment model. That is, a user/profile will be associated with different user interests in different contexts. For example, if a user browses a software application for restaurant recommendations on a model device at noon on a workday, a user interest might be expressed as “restaurants close to a current location,” while a same or similar user logging into the same application during a weekend evening might be associated with a user interest of “restaurants close to the city center with high average customer ratings.”

The context might be represented as shown in Equation 3:

c_{q}=<time, location, click through data, login time, . . . > Equation 3

Patterns may then be generated (414), where, as referenced above, patterns may be expressed as ordered lists of information entities of the entity data 110, where the ordering is implemented based on relative levels of relevance of each information entity to the pattern being formed. Consequently, a pattern may be represented in the manner shown in Equation 4:

pᵢ( )→<eₖ_{₁}, eₖ_{₂}, eₖ_{₃}, eₖ_{₄}, . . . >} Equation 4

As described above, a pattern might include an example such as “user prefers to sort hotels according to distance from city center, and in ascending price order.” A pattern also might be expressed as “user wants to find products similar to the Apple iPhone 6,” or “user hopes to find accessories for Apple iPhone 6.”

In more specific example implementations, patterns may be inferred using appropriate statistical methods. For example, patterns may be generated using a topic model-based machine learning algorithm that assigns entities to patterns based on entity-specific user interactions of the user interactions. Such topic-model based, or topical, models are generally based on an assumption that within documents or collections of words/actions, one or more topics may be included, and in varying proportions. For example, a document directed to topic “1” might contain a large proportion of related words A, B, C, while a document directed to topic “2” might contain a large proportion of related words D, E, F. A single document directed twenty percent to topic 1 and eighty percent to topic 2 might contain a 20/80 proportion of words A, B, C to words D, E, F, and so on.

Based on these and similar or related assumptions, a topic model generates statistics regarding inclusions of various words within various documents, and infers related topics. Such techniques may be executed by the pattern generator 124, by treating user actions as “documents,” and patterns as “topics.” In other words, by examining sets or collections of user actions, topics (absolute and relative/proportional) may be inferred.

In a particular example implementations, the Latent Dirichlet allocation (LDA) is a specific type of topic model that allows observation sets to be explained by groups, based on some parts of the data being similar. As just referenced, LDA might use documents (user actions) and a desired number of topics as inputs, to provide an output of topics (patterns). The patterns may be combined based on inferred proportional interest levels of the user.

That is, as described, a user interest may be defined as a mixture or combination of two or more patterns, with a weight attached to each pattern, so that the aggregation of weighted patterns accurately and completely reflects a user interest of a user. For instance, in a simplified example, a user interest might be expressed as a weight adjustment model in which a pattern p1 of “sort hotels according to distance to city center” receive the weight of 0.8, while a pattern p2 of sorting hotels according to average daily rates might receive a weight of 0.2.

As already described with respect to FIG. 4, the recorded context provides a link between the user profile, the user browsing behavior, and the user interest expressed as a weighted combination of patterns. Thus, a function for finding or expressing user interest might be provided in the manner shown in Equation 5:

R(uᵢ, c_{q}, bᵢ₍ₜᵢₘₑ₎):→user interest{<weight₁, p₁>, <weight₂, p₂>, . . . } Equation 5

Using the generated patterns, one or more weight adjustment models may be generated (416). At this stage, the weight adjustment model can be formulated independently of screen size(s). Rather, the weight adjustment model or function can be created based on the user profile, the context(s), the pattern(s), and the user interest(s) that have already been created/accessed/inferred.

For example, the Expectation and Maximization (EM) algorithm may be used to infer the weight adjustment function. In more detail, the EM algorithm assumes that the weight adjustments are latent (i.e., hidden, unknown) variables, and uses an iterative method to alternate between an expectation operation based on a current estimate for a likelihood of correct values for the weights, and a maximization step that calculates weight values that would maximize the expected likelihood, so that in the next iteration a new estimate/expectation may be calculated based on the results of the maximization.

Of course, the generated weight adjustment model also reflects the screen size data recorded in conjunction with the context data and/or the browsing data. In particular, in the example of FIG. 4, it is assumed that, given the same user profile, context information, and user browsing behavior, the user interest expressed as weighted combinations of patterns will differ only in the relative weights of each pattern with respect to different screen sizes. That is, although the user may have two different devices with different screen sizes, the user's interest will generally be similar across the different screen sizes. For example, if a pattern “searches for hotels close to city center” is assigned a high weight for a relatively larger screen, then, given a same user profile and context, the weight of that pattern and a smaller screen will be reinforced. More particularly, a weight adjustment model incorporating screen size adjustments may be expressed as shown in the example of Equation 6:

F(R(uᵢ, c_{q}, bᵢ₍ₜᵢₘₑ₎), s_{current}, s_{reference})=user interest{<f₁(weight₁, s_{current}, s_{reference}), p₁>, <f₂(weight₂, s_{current}, s_{reference}), p₂>, . . . } Equation 6

In Equation 6, s_{current} represents a current screen size, while s_{reference} represents a reference or standard screen size. Then, fₖ(weight k, s_{current},s_{reference}) represents a new, post-adjustment weight obtained based on an original weight, with no assumption of learning from the different screen sizes.

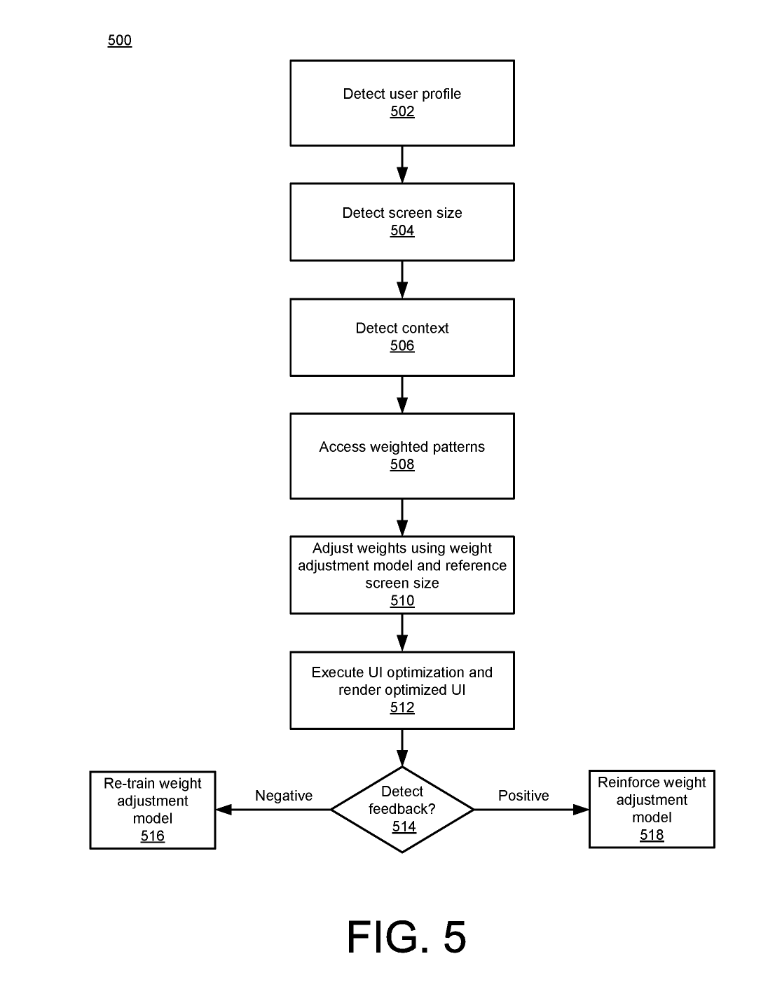

FIG. 5 is a flowchart 500 illustrating example operations of the rendering engine 114 of FIG. 1. That is, as described, the rendering engine 114 is configured to leverage the data mining and machine learning performed by the screen size adjustment model generator 112 that reflects how different patterns from different screen sizes are used, to thereby construct weight adjustment models reflect in a manner in which screen sizes, user browsing behavior, context, and user profiles influence representations of user interest of the user. More particularly, when current/new user behavior is obtained, the rendering engine 114 is configured to utilize the current/new user behavior as an input to the previously-calculated weight adjustment model, so that the relevant user interest is adjusted to reflect current conditions. Then, based on the updated user interest, layout optimization may be executed, as described herein.

Thus, in FIG. 5, at a time of calculating a current user interest for a current screen size, a user profile may be detected (502), if a relevant user profile has not already been loaded. Similarly, a current screen size may be detected (504), and a current context may be detected (506), as well. In other words, during the rendering phase, the rendering engine 114 may be configured to determine current values for the same or similar parameters previously used by the screen size adjustment model generator 112, and may thereafter utilize the current values for inputs to the calculated weight adjustment model, to thereby optimize a current layout for the application 104 using the relevant screen size.

Accordingly, the rendering engine 114, e.g., the pattern calculation engine 132, may proceed to calculate current instances of weighted patterns, e.g., user interest, (508). As referenced above, the inference function of LDA, or other appropriate technique, may be used here to determine the incoming user interest.

Then, the calculated weights may be adjusted using the previously determined weight adjustment model, including the assigned reference screen size (510). For example, the weight adjustment engine 134 may execute equation 6 to determine relative levels of importance of each pattern with respect to one another, and with respect to the screen size of the screen in which the application has been requested for rendering.

The UI optimizer 136 may thereafter execute a corresponding UI optimization for rendering of the optimized UI and the screen for which rendering has been requested (512). For example, the UI optimizer 136 may be configured to, e.g., filter an order of entities to be rendered in accordance with the user interest. In additional or alternative implementations, the UI optimizer 136 may be configured to assign different sizes or locations of individual application entities.

If detected feedback (514) is negative, then the weight adjustment model may be retrained (516) to reflect and remedy a lack of success of operations of the screen size adjustment model generator 112 in accurately generalizing and predicting user preferences. For example, an entity that was provided with a relatively high importance level using the techniques of FIG. 4, but that was ignored or dismissed by the user during a particular application rendering, may be ignored or assigned a much lower priority level for subsequent renderings. Moreover, the weight adjustment model may be reflected in a manner which captures and expresses such updated characterizations of the user interest.

On the other hand, if detected feedback is positive, the weight adjustment model may be reinforced (518). For example, if a particular entity was assigned a relatively high importance level, and was thereafter rendered prominently and selected by the user, then the weight adjustment model may be reinforced with a higher confidence level in the assigned weight for the entity in question, and/or may assign a relatively higher weight thereto.

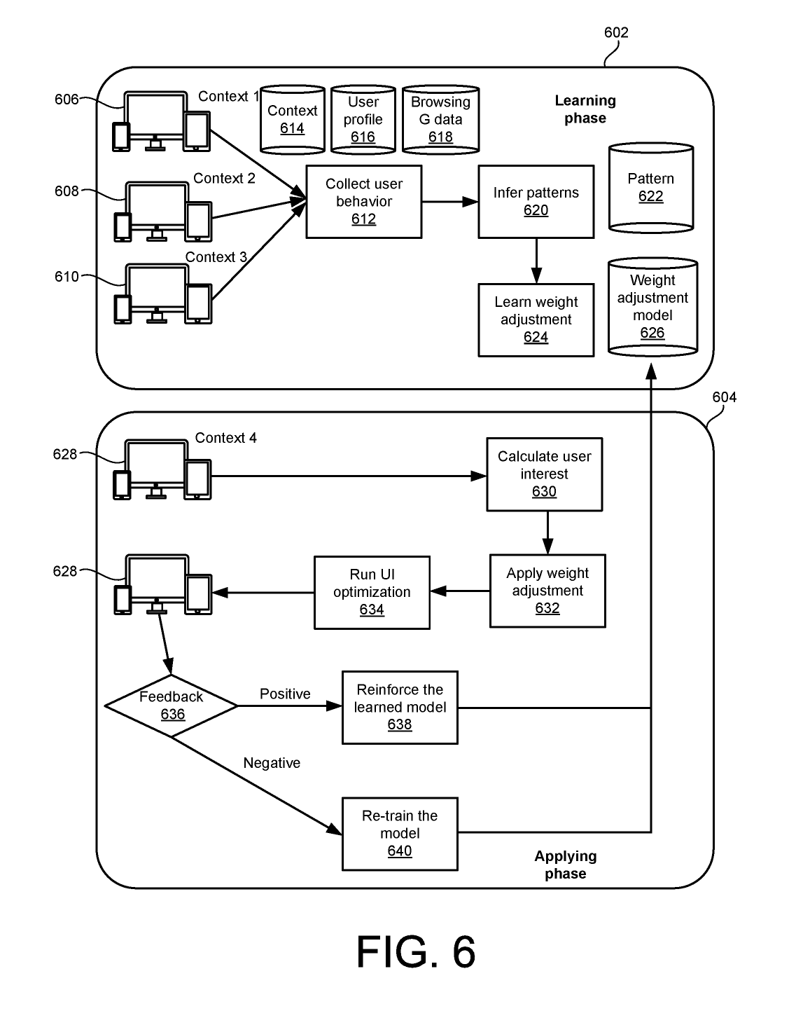

FIG. 6 is a block diagram of a process flow for the system 100 of FIG. 1. In general, as shown, FIG. 6 includes a learning phase 602 that corresponds generally to the example operations of FIG. 4, as well as an applying phase 604 that corresponds generally to the example implementations of FIG. 5. As shown, during the learning phase 602, learning may occur with respect to monitored user behavior or interactions determined in conjunction with a plurality of different context, illustrated in the example of FIG. 6 as contexts 606, 608, and 610.

In other words, user behavior is collected (612), and stored as context data 614, user profile data 616, and browsing data 618. As described, the collected data may include the various screen sizes associated with the various devices of the context 606, 608, 610.

The patterns of ordered listings of entities may then be inferred from the collected data (620). In this way, various inferred patterns may be stored in an appropriate database (602). In response to these operations of the pattern generator 124, the weight model generator 128 may be configured to generate the corresponding weight adjustment model (624), for storage within weight adjustment model database 626.

Within the applying phase 604, a new context 628 is illustrated as being utilized by the user. Accordingly, the pattern calculation engine 132 of the rendering engine 114 may proceed to calculate a user interest (630) represented by one or more patterns obtained based on current values of monitored data (e.g., context, user profile, and/or browsing actions). Once determined, the weight adjustment engine 134 may apply any necessary weight adjustments (632), to obtain a desired level of personalization in the rendering of the application.

Accordingly, a UI optimization may be run (634) by the UI optimizer 136, resulting in execution of the rendering in the context 628. Upon receipt of direct or detected feedback (636), the feedback handler 138 may cause either reinforcement of the existing weight adjustment model (638) for positive feedback, or re-training of the weight adjustment model for negative or unexpected feedback (640).

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed, are configured to cause at least one computing device to:
detect user interactions with a first subset of application entities of at least one network application included in a graphical user interface (GUI) rendered by a first device having a first screen size;
assign relative levels of importance to the first subset of application entities of the at least one network application, based on the detected user interactions;
receive a request to render the at least one graphical user interface for a second device having a second screen size; and
render, in response to the request, a second subset of the application entities of the at least one network application within the at least one graphical user interface and using the second device, based on the relative levels of importance and on relative screen sizes of the first screen size and the second screen size.

2. The computer program product of claim 1, wherein the instructions, when executed by the at least one computing device, are further configured to:
detect the user interactions including selections made by a user among the first subset of application entities of the at least one network application.

3. The computer program product of claim 1, wherein the instructions, when executed by the at least one computing device, are further configured to:
detect the user interactions including determining a situational context of a user performing the user interactions; and
render the second subset of the application entities based on the situational context, and on a current context of the user at a time of the rendering.

4. The computer program product of claim 1, wherein the instructions, when executed by the at least one computing device, are further configured to:
assign the relative levels of importance including training a model of a machine learning algorithm as a function of screen size, using the user interactions; and
render the second subset of the application entities including applying the trained model to the application entities of the at least one network application.

5. The computer program product of claim 1, wherein the instructions, when executed by the at least one computing device, are further configured to:
detect the user interactions with the first subset of application entities in conjunction with a user profile characterizing a user performing the user interactions, wherein the relative levels of importance are stored in conjunction with the user profile.

6. The computer program product of claim 1, wherein the instructions, when executed by the at least one computing device, are further configured to assign the relative levels of importance including:
storing at least two ordered entity lists from the first subset of application entities, each ordered entity list reflecting relative levels of importance of each included entity with respect to a user performing the user interactions, and each ordered entity list representing a pattern of behavior of the user; and
assigning a weight to each pattern to obtain a combination of weighted patterns, the weights reflecting relative levels of importance of each pattern to the user, and the combination of weighted patterns reflecting at least one user interest of the user.

7. The computer program product of claim 6, wherein the instructions, when executed by the at least one computing device, are further configured to assign the relative levels of importance including:
generating the patterns using a topic model-based machine learning algorithm that assigns entities to patterns based on entity-specific user interactions of the user interactions.

8. The computer program product of claim 6, wherein the instructions, when executed by the at least one computing device, are further configured to assign the relative levels of importance including:
generating a weight adjustment model using the assigned weights and associated patterns, the weight adjustment model being generated as a function of screen size.

9. The computer program product of claim 1, wherein the instructions, when executed by the at least one computing device, are further configured to:
render the second subset of the application entities including executing a layout optimization thereof with respect to the second screen size.

10. The computer program product of claim 1, wherein the instructions, when executed by the at least one computing device, are further configured to:
determine feedback related to a user experience of a user with respect to the rendered second subset of the application entities; and
update the relative levels of importance, based on the feedback.

11. The computer program product of claim 1, wherein the user interactions include user interactions detected across a plurality of network applications, including the at least one network application.

12. A method of executing instructions stored on a non-transitory computer-readable storage medium using at least one processor, the method comprising:
detecting user interactions with a first subset of application entities of at least one network application included in a graphical user interface (GUI) rendered by a first device having a first screen size;
assigning relative levels of importance to the first subset of application entities of the at least one network application, based on the detected user interactions;
receiving a request to render the at least one graphical user interface for a second device having a second screen size; and
rendering in response to the request, a second subset of the application entities of the at least one network application within the at least one graphical user interface and using the second device, based on the relative levels of importance and on relative screen sizes of the first screen size and the second screen size.

13. The method of claim 12, wherein:
assigning the relative levels of importance includes training a model of a machine learning algorithm as a function of screen size, using the user interactions; and
rendering the second subset of the application entities includes applying the trained model to the application entities of the at least one network application.

14. The method of claim 12, wherein assigning the relative levels of importance includes:
storing at least two ordered entity lists from the first subset of application entities, each ordered entity list reflecting relative levels of importance of each included entity with respect to a user performing the user interactions, and each ordered entity list representing a pattern of behavior of the user; and
assigning a weight to each pattern to obtain a combination of weighted patterns, the weights reflecting relative levels of importance of each pattern to the user, and the combination of weighted patterns reflecting at least one user interest of the user.

15. The method of claim 14, wherein assigning the relative levels of importance includes:
generating a weight adjustment model using the assigned weights and associated patterns, the weight adjustment model being generated as a function of screen size.

16. A system comprising:
at least one processor;
a non-transitory computer-readable storage medium storing instructions executable by the at least one processor, the system including
a screen size adjustment model generator configured to cause the at least one processor to generate, based on user profile data and user browsing data of a user, at least two patterns of ordered lists of application entities, the application entities having been rendered within a graphical user interface associated with at least one network application, the screen size adjustment model generator being further configured to cause the at least one processor to generate a weight adjustment model in which a weight is assigned to each of the at least two patterns and the weight reflects relative levels of important to the user as a function of screen size;
a rendering engine configured to cause the at least one processor to render, based on a current screen size of a screen of the user, the graphical user interface including a subset of the application entities selected and arranged using the weight adjustment model.

17. The system of claim 16, wherein the screen size adjustment model generator is further configured to cause the at least one processor to:
receive feedback related to a user experience of the user with respect to the rendered subset of the application entities; and
update the weight adjustment model, based on the feedback.

18. The system of claim 16, wherein the screen size adjustment model generator is further configured to cause the at least one processor to:
detect the browsing data including determining a situational context of the user during the browsing data; and
construct the weight adjustment model as a function of the situational context.

19. The system of claim 18, wherein the rendering engine is further configured to cause the at least one processor to render the subset of the application entities based a current context of the user at a time of the rendering.

20. The system of claim 16, wherein the rendering engine is further configured to cause the at least one processor to render the subset of the application entities including executing a layout optimization thereof with respect to the current screen size of the screen of the user.
